(19) United States
(12) Patent Application Publication
(10) Pub. No.: US 2007/0274000 A1
(43) Pub. Date: Nov. 29, 2007

(54) Disk drive, method for controlling the same, and method for manufacturing the same

(75) Inventors: Haruo Andoh, Kanagawa (JP); Taku Kitagawa, Kanagawa (JP)

Correspondence Address: TOWNSEND AND TOWNSEND AND CREW LLP, TWO EMBARCADERO CENTER, 8TH FLOOR, SAN FRANCISCO, CA, 94111, US

(73) Assignee: Hitachi Global Storage Technologies Netherlands B.V., Amsterdam (NL)

(21) Appl. No.: 11/807,034

(22) Filed: May 25, 2007

(30) Foreign Application Priority Data
May 25, 2006 (JP) 2006-145024

(51) Int. Cl. G11B 21/02

(52) U.S. Cl. 360/75

(57) ABSTRACT

Embodiments in accordance with the present invention prevent abnormal action of the actuator of a disk drive. According to an embodiment of the invention, in the process of startup (power on reset (POR)), a hard disk drive (HDD) checks whether an arm electronics (AE) port table stored in an EEPROM agrees with the ports of an AE to which head device portions are actually connected before it starts the rotation of a magnetic disk to move the actuator onto a user data area. Thus, even if an HDA and a reused circuit board do not agree at the manufacture of the HDD, the abnormal action of the actuator can be prevented.

### CROSS-REFERENCE TO RELATED APPLICATION

The instant nonprovisional patent application claims priority to Japanese Application No. 2006-145024 filed May 25, 2006 and incorporated by reference in its entirety herein for all purposes.

### BACKGROUND OF THE INVENTION

Known disk drives include a disk drive that uses various media such as optical disks, magneto-optical disks, or flexible magnetic disks. Among them, hard disk drives (HDDs) have come into wide use as the storage device of computers, and have become a storage device indispensable for the present computer systems. The application of HDDs is getting wider and wider because of their excellent features not only for computer systems but also for moving-picture recording and reproducing apparatuses, car navigation systems, and removable memories for use in cellular phones or digital cameras.

HDDs are equipped with a magnetic disk on which data is stored and a head slider for accessing the magnetic disk. The head slider includes a head device portion for reading and/or writing data from/to the magnetic disk and a slider on which the head device portion is provided. HDDs further include an actuator for moving the head slider to a desired position on the magnetic disk. The actuator is driven by a voice coil motor (VCM) to rotate about the rotation axis, thereby moving the head slider in the radial direction on the rotating magnetic disk. Thus, the head device portion gets access to a desired track on the magnetic disk, and reads/writes the data.

In the manufacture of an HDD, after the components have been combined, the HDD is connected to an external testing unit, and the setting and adjustment of various parameters, performance test, etc are performed. When activated by external power source, general HDDs read parameters stored in an EEPROM, and the head has access to the magnetic disk on the basis of the read parameters to enter a standby mode (I/F Ready) (a state in which normal data communications with external unit are available).

When performing the above-mentioned test or parameter setting after the HDD has been assembled, an error always occurs in the EEPROM when the HDD is activated in connection with the tester, because the EEPROM is in the initialized state. To come into a standby state without rotating the magnetic disk, the tester sends a command and data to the HDD in the standby state. The HDD rewrites the data in the EEPROM according to the command and data.

Japanese Patent Publication No. 10-241128 (“Patent Document 1”) discloses a technique of determining the quality of a head after the shipment of an HDD on the basis of a signal read from the head, although it is different in feature from the present invention.

After parameters have been stored in the EEPROM, the HDD is tested. When only a head disk assembly (HDA) has a defect and a circuit board combined with the HDA is normal, the circuit board will be reused. The EEPROM of the circuit board to be reused has already stored the parameters. Since the parameters set in the EEPROM are not for checking matching, the HDD combined with the reused circuit board, when activated, causes no EEPROM error and determines that the parameters stored in the EEPROM are correct, and thus starts the rotation of the magnetic disk to drive the actuator, thereby moving the head slider to an area on which user data is stored.

In this case, when the parameters stored in the EEPROM and the structure of the HDA do not match, the actuator in the HDD may perform unexpected action. Specifically, when the number of the heads of the HDA and the number of the heads indicated by the parameters stored in the EEPROM are different, firmware may execute servo control by reading servo data on the magnetic disk with a nonexistent head device portion, causing the actuator to execute unexpected action. For example, the actuator collides with a crash stop to damage the head slider or the magnetic disk by the impact at that time.

Therefore, when reusing the circuit board, it is necessary to eliminate the parameters stored in the EEPROM by initializing the EEPROM etc. before combining the circuit board to be reused with the HDA, which causes a decrease in productivity.

### BRIEF SUMMARY OF THE INVENTION

Embodiments in accordance with the present invention prevent abnormal action of the actuator of a disk drive. According to the particular embodiment of FIG. 1, in the process of startup (power on reset (POR)), an HDD 1 checks whether an arm electronics (AE) port table stored in an EEPROM 25 agrees with the ports of an AE 13 to which head device portions 12 are actually connected before it starts the rotation of a magnetic disk 11 to move the actuator 16 onto a user data area. Thus, even if an HDA and a reused circuit board do not agree at the manufacture of the HDD 1, the abnormal action of the actuator 16 can be prevented.

### BRIEF DESCRIPTION OF THE DRAWINGS

FIG. 1 is a schematic block diagram showing the overall structure of an HDD according to an embodiment of the invention.

FIG. 2 is a schematic block diagram showing logical components for AE port checking according to an embodiment of the invention.

FIG. 3 shows an example of an AE port table according to an embodiment of the invention.

FIG. 4 is a flowchart for the sequence of AE port checking according to an embodiment of the invention.

FIGS. 5(a)-5(d) show examples of the AE port table and the actual connection between AE ports and heads, according to an embodiment of the invention.

### DETAILED DESCRIPTION OF THE INVENTION

Embodiments in accordance with the present invention relate to a disk drive, a method for controlling the same, a method for manufacturing the same, and more particularly, relate to determination of the condition of a head of the disk drive.

A disk drive according to an aspect of embodiments of the invention comprises: one or a plurality of disks on which data is stored; one or a plurality of heads that reads the data on the one or plurality of disks; a head moving mechanism that supports and moves the one or plurality of heads; one or a plurality of connecting portions connected to the one or plurality of heads, respectively; and a controller that determines the condition of at least one of the heads registered on a table that associates the connecting portions with the one or plurality of heads with reference to the table before the head moving mechanism moves the head. Since the condition of at least one of the heads registered on the table is checked before the head moving mechanism moves the head, the abnormal action of the head moving mechanism can be prevented.

When the condition of the head is determined to be in error, the controller may become communicable with an external unit before the head moving mechanism moves the head. This allows an indication to execute a process for coping with the head error to be given by an external unit.

The controller may execute the determination in the process of manufacturing the disk drive. This allows determination whether the table and the actual head and connecting portion agree with each other. Furthermore, when the condition of the head is determined to be in error, the controller may start communication with an external unit before the head moving mechanism moves the head, and rewrites the table according to the instruction from the external unit. This eliminates the disagreement between the table and the actual head and connecting portion.

The controller may determine whether the head registered on the table is connected to the head connecting portion. This allows determination whether the table and the actual head and connecting portion agree with each other. Furthermore, the controller may execute the determination before the disk is rotated, thereby omitting unnecessary operations.

According to another aspect of embodiments of the present invention, there is provided a method for controlling a disk drive including one or a plurality of heads that reads data from one or a plurality of disks and a head moving mechanism that supports and moves the one or plurality of heads. The method comprises: referring to a table that associates connecting portions with the one or plurality of heads; determining the condition of at least one of the heads registered on the table before the head moving mechanism moves the head; and starting communication with an external unit before the head moving mechanism moves the head, when the determination indicates an error. In an example, the determination is made on the basis of the result of checking whether the head device is in open state.

A method for manufacturing a disk drive according to a still another aspect of embodiments of the present invention comprises: manufacturing a head disk assembly by mounting, in a case, one or a plurality of disks, one or a plurality of heads that reads data from the one or plurality of disks, a head moving mechanism that supports and moves the one or plurality of heads, and a preamplifier IC to which the one or plurality of heads are connected; connecting a circuit board containing a memory that stores a table and a controller with the head disk assembly, the table associating connecting portions with the one or plurality of heads; and determining the condition of at least one of the heads registered on the table by the controller before the head moving mechanism moves the head.

According to embodiments of the invention, the abnormal action of the head moving mechanism can be prevented.

An embodiment of the present invention will be described hereinbelow. For the purpose of clear description, the following description and drawings have omission and simplification as appropriate. In the drawings, the same components have the same numerals, and for the purpose of clear description, duplicate descriptions are omitted as necessary. Here an embodiment of the invention will be described with a hard disk drive (HDD) as an example of a disk drive. The HDD of the embodiment checks the condition of the head device portion before moving the head device portion from the retracting position, particularly, whether a registered head device portion is actually connected to a corresponding connecting portion. Thus the damage of the head device portion and the magnetic disk due to the abnormal action of the actuator is prevented.

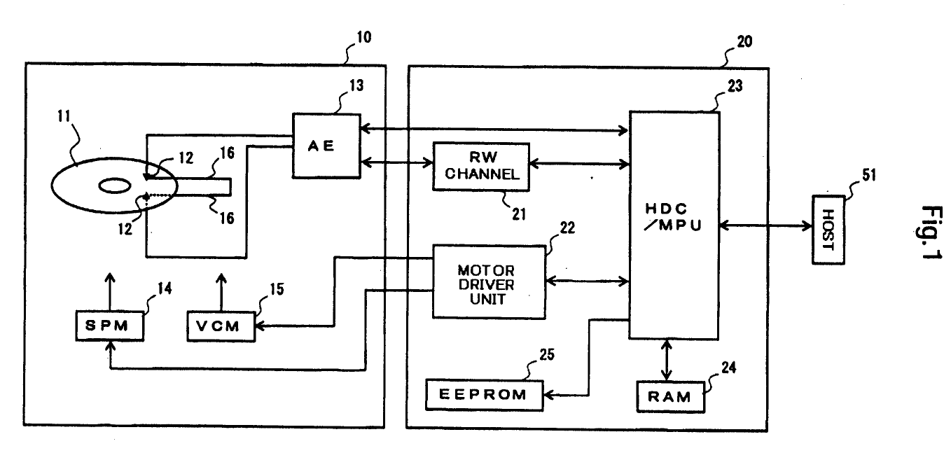

For easy understanding of the features of the embodiment, the overall structure of the HDD will be described first. FIG. 1 is a schematic block diagram of the overall structure of an HDD 1 according to the embodiment. As shown in FIG. 1, the HDD 1 includes, in an enclosure 10, a magnetic disk 11 which is an example of a disk on which data is stored, a head device portion 12, an arm electronics (AE) 13, a spindle motor (SPM) 14, a voice coil motor (VCM) 15, and an actuator 16. They are referred to as a head disk assembly (HDA).

The HDD 1 includes a circuit board 20 fixed to the outside of the enclosure 10. The circuit board 20 includes ICs thereon, such as a read write channel (RW channel) 21, a motor driver unit 22, a hard disk controller (HDC) and MPU integrated circuit (hereinafter, referred to as an HDC/MPU) 23, a RAM 24, and an EEPROM 25. The circuit components can be integrated to one IC or divided in two or more ICs.

The SPM 14 rotates the magnetic disk 11 fixed thereto at a predetermined angular speed. The motor driver unit 22 drives the SPM 14 according to the control data from the HDC/MPU 23. The magnetic disk 11 of the embodiment has data recording surfaces on both sides. The head device portions 12 are provided in correspondence with the recording surfaces.

The head device portion 12 as an example of a head, is fixed to a slider (not shown). The slider is fixed to the actuator 16 which is an example of the head moving mechanism. In reading or writing data, the slider levitates on the rotating magnetic disk 11. The actuator 16 is connected to the VCM 15, and rotates about the rotation axis to move the head device portions 12 (and the sliders) in the radial direction on the magnetic disk 11.

The motor driver unit 22 drives the VCM 15 according to the control data from the HDC/MPU 23. The head device portions 12 typically include a write element that converts an electric signal to a magnetic field according to write data and a read element that converts a magnetic field from the magnetic disk 11 to an electric signal. There should be one or more magnetic disks 11. The recording surface of the magnetic disk 11 may be provided on one or both sides thereof. Embodiments of the invention may be applied to a data storage device including only the read element.

The AE 13 selects one of the head device portions 12 which makes access to data, amplifies (preamplifies) the signal reproduced by the selected head device portion 12 with a fixed gain, and sends it to the RW channel 21. The AE 13 sends the recording signal from the RW channel 21 to the selected head device portion 12. The AE 13 of the embodiment has the function of measuring the open/short and the resistances of the read element and the write element, with which the connecting state of the head device portions 12 can be determined. This will be described later.

In the writing process, the RW channel 21 modulates the code of the write data supplied from the HDC/MPU 23, converts the modulated code of the write data to a write signal, and supplies it to the AE 13. In the reading process, the RW channel 21 amplifies the read signal supplied from the AE 13 to a predetermined value for obtaining a constant amplitude, extracts data from the obtained read signal, and decodes it. The read data includes user data and servo data. The decoded read data is supplied to the HDC/MPU 23.

In the HDC/MPU 23, the MPU operates according to the microcode loaded on the RAM 24. As the HDD 1 is activated, the RAM 24 is loaded with the microcode that operates on the MPU and data necessary for control and data processing from the magnetic disk 11 or a ROM (not shown). The RAM 24 is also loaded with necessary parameters from the EEPROM 25. The HDC is configured as a logic circuit, and executes various processes in connection with the MPU. For example, the HDC/MPU 23 performs processes necessary for data processing including management of the order of execution of commands, control of the positioning of the head device portions 12, control of the interface, and management of defects and also the overall control for the HDD 1. The HDC/MPU 23 of this embodiment particularly executes the process of checking the connecting state of the head device portions. This will be described later.

The HDC/MPU 23 transfers the read data from the magnetic disk 11 which is obtained from the RW channel 21 to a host 51. The read data from the magnetic disk 11 is temporarily stored in the read buffer in the RAM 24, and then transferred to the host 51 via the HDC/MPU 23. The write data from the host 51 is temporarily stored in the write buffer in the RAM 24 via the HDC/MPU 23, and then transferred to the magnetic disk 11 via the HDC/MPU 23 at a predetermined timing.

In the process of manufacturing the HDD 1, the components are mounted in the enclosure 10 to manufacture the HDA. Specifically, a head stack assembly (HSA) which is an assembly of the head slider and the actuator 16, the SPM 14, magnets of the VCM 15, and the magnetic disk 11 are mounted. The AE 13 is fixed to the actuator 16 in the process of manufacturing the HSA. After that, the circuit board 20 is mounted on the back of the enclosure 10 of the HDA to manufacture the HDD 1. The components in the HDA and the circuit board 20 are connected by a flexible cable extending from the enclosure 10.

The assembled HDD 1 is connected to a dedicated tester (test computer), where parameters are set and adjusted, and the performance is tested before shipment. At the setting and adjustment of parameters, a table indicative of the correspondence between the logic numbers (logic head numbers) of the head device portions 12 and the port numbers of the AE 13 (hereinafter, referred to as an AE port table), the channel parameter of the RW channel 21, and parameters that determine write currents when the head device portions 12 write data on the magnetic disk 11 are stored in the HDD 1. The HDD 1 that has passed the performance test is shipped as a product.

When the factory performance test determines that only the HDA has defects and the circuit board 20 combined with the HDA is normal after the HDD 1 has been assembled, the circuit board 20 is reused. The parameter of the circuit board 20 to be reused has already been stored in the EEPROM 25. Accordingly, if the agreement between the AE port table stored in the EEPROM 25 and the head device portion 12 connected to the actual AE port is not checked, the actuator 16 is driven with an unconnected AE port of the head device portion 12 selected. As a result, no servo data can be read. Thus, the actuator 16 may perform unexpected action to damage the head device portion 12 or the magnetic disk 11.

The HDD 1 of this embodiment checks the agreement between the AE port table stored in the EEPROM 25 and the ports of the AE 13 to which the head device portions 12 are actually connected before the rotation of the magnetic disk 11 is started to move the actuator 16 (the head device portions 12) to the user data area in the process at startup (power on reset (POR)).

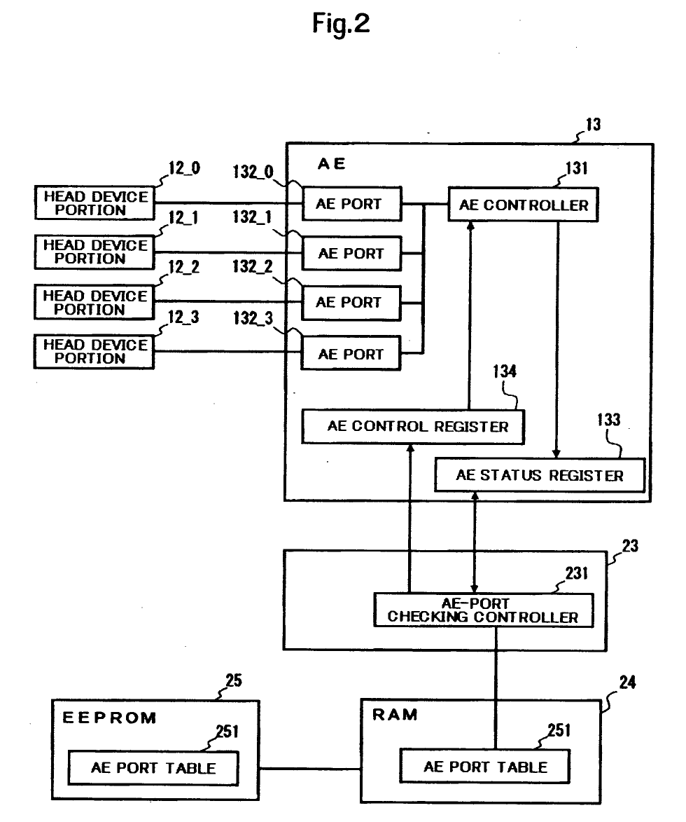

The HDD 1 executes the checking as a function of itself. Specifically, as shown by the block diagram in FIG. 2, the MPU in the HDC/MPU 23 performs the process according to the installed program to function as an AE-port checking controller 231. FIG. 2 shows an example in which four head device portions 12_0 to 12_3 are connected to head-connecting ports 132_0 to 132_3 of the AE 13.

The AE port checking of this embodiment can be applied to both load/unload type HDDs and contact start/stop (CSS) type HDDs. With the load/unload type, the head slider (actuator 16) is in the lamp stop position (the retracted position) at non-operating time. With the CSS type, the head slider is in the stop position (the retracted position) of the innermost periphery of the magnetic disk 11.

As shown in FIG. 2, the AE-port checking controller 231 executes AE port checking using the function (the function of an AE controller 131) installed in the AE 13. The AE controller 131 can check the characteristics of the head device portions 12_0 to 12_3. Specifically, the AE controller 131 can measure the open/short of the read element and the write element and the resistances of the read element and the write element. This function allows determination of the connecting state of the head device portions 12_0 to 12_3. The function suitable for determination of the connecting state of the head device portions is a read-element-open detecting function. An example of using the function will be described.

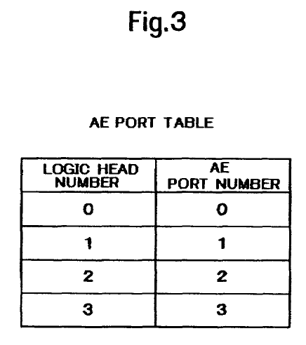

The AE-port checking controller 231 refers to an AE port table 251 loaded on the RAM 24 from the EEPROM 25. FIG. 3 shows an example of the AE port table 251. The example shows that the AE port numbers 0 to 3 are connected to the head device portions of the logic head numbers 0 to 3, respectively.

The AE-port checking controller 231 obtains an AE port number from the AE port table 251, and instructs the AE controller 131 to check whether a read element indicative of the number is in open state. Specifically, the AE-port checking controller 231 stores the AE port number and the instruction to check whether the read element is open in an AE control register 134 of the AE 13.

The AE controller 131 selects an AE port of the indicated number from the AE ports 132_0 to 132_3 with reference to the AE control register 134, and checks whether the read element connected to the port is in open state. The AE controller 131 stores the check result in an AE status register 133. The AE-port checking controller 231 can acquire the check result by referring to the AE status register 133. The AE-port checking controller 231 acquires the AE port numbers in sequence from the AE port table 251, and repeats the process of checking whether the read element is in open state. Thus, the AE-port checking controller 231 determines whether the information of the AE port table 251 is correct.

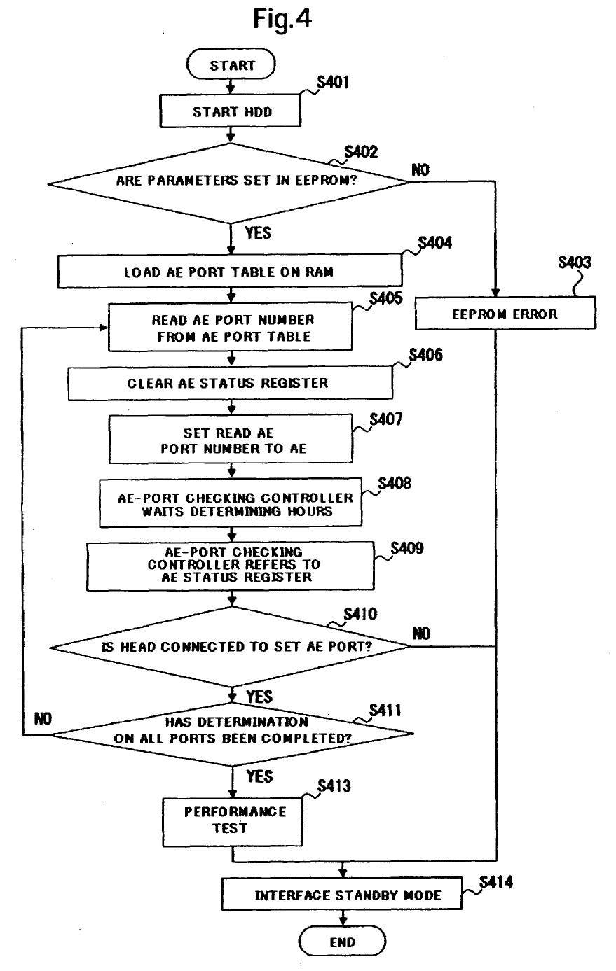

FIG. 4 is a flowchart for the POR process of the HDD 1 according to an embodiment. When power is turned on to start the HDD 1 (S401), the HDC/MPU 23 determines whether parameters have been set in the EEPROM 25 (S402). In this case, the HDC/MPU 23 may determine only whether the AE port table 251 has been stored.

When no parameter setting and performance test have yet been conducted after the assembly of the HDD 1, no parameter has not been set in the EEPROM 25 (No in S402), which causes an EEPROM error (S403). In this case, the HDC/MPU 23 registers the error in an interface register (not shown), and proceeds to an interface standby mode (I/F Ready) (S414) without spinning up the magnetic disk 11 and moving the head by the actuator 16. Thus, the POR process is finished. In the interface standby mode, the HDC/MPU 23 and the tester can perform data communications. The tester sends a command and data to the HDC/MPU 23 in standby mode, and the HDC/MPU 23 writes predetermined data into the EEPROM 25 according thereto.

When parameters have been set and the AL port table 251 has been stored in the EEPROM 25 (Yes in S402), the HDC/MPU 23 loads the AE port table 251 on the RAM 24 (S404). The AE-port checking controller 231 reads an AE port number from the AE port table 251 (S405). The AE-port checking controller 231 clears the AE status register 133 (S406), and sets the read AE port number and the instruction to check whether the read element is in open state to the AE control register 134 (S407).

After setting the AE port number and the instruction, the AE-port checking controller 231 waits by the determining hours (S408). While the AE-port checking controller 231 is waiting, the AE controller 131 in the AE 13 checks whether the read element of the selected AE port 132 is in open state, as described above, and stores the result in the AE status register 133.

After the determining hours have passed (S408), the AE-port checking controller 231 acquires the stored determination result with reference to the AE status register 133 (S409). The AE-port checking controller 231 determines, according to the result, whether a head device portion 12 is connected to the set AE port number (S410). In the case of open error, the AE-port checking controller 231 determines that no head device portion is connected (No in S410).

Since the information of the AE port table 251 stored in the EEPROM 25 is incorrect, the HDC/MPU 23 proceeds to the interface standby mode (S414) without spinning up the SPM 14 and driving the actuator 16, and thus the POR process is finished. Thereafter, the HDC/MPU 23 writes predetermined data into the EEPROM 25 according to the instruction from the tester.

In contrast, when the result obtained from the AE status register 133 indicates that the read element is normal, the AE-port checking controller 231 determines that there is no problem because a head device portion is connected to the AE port number (Yes in S410). The AE-port checking controller 231 then determines whether all the AE ports set on the AE port table 251 have been checked (S411). When the checking on all the AE ports has not been completed (No in S411), the next AE port number is read from the AE port table 251 (S405), and checking is started again (S405 to S410).

When the checking on all the AE ports set on the AE port table 251 has been completed (Yes in S411), the AE-port checking controller 231 determines that the information set on the AE port table 251 is correct information corresponding to the HDA fitted with the circuit board 20. The HDC/MPU 23 executes a predetermined performance test including a read operation and a write operation (S413), and proceeds to the interface standby mode (S414). Then, the HDC/MPU 23 writes predetermined data into the EEPROM 25 according to the instruction of the tester.

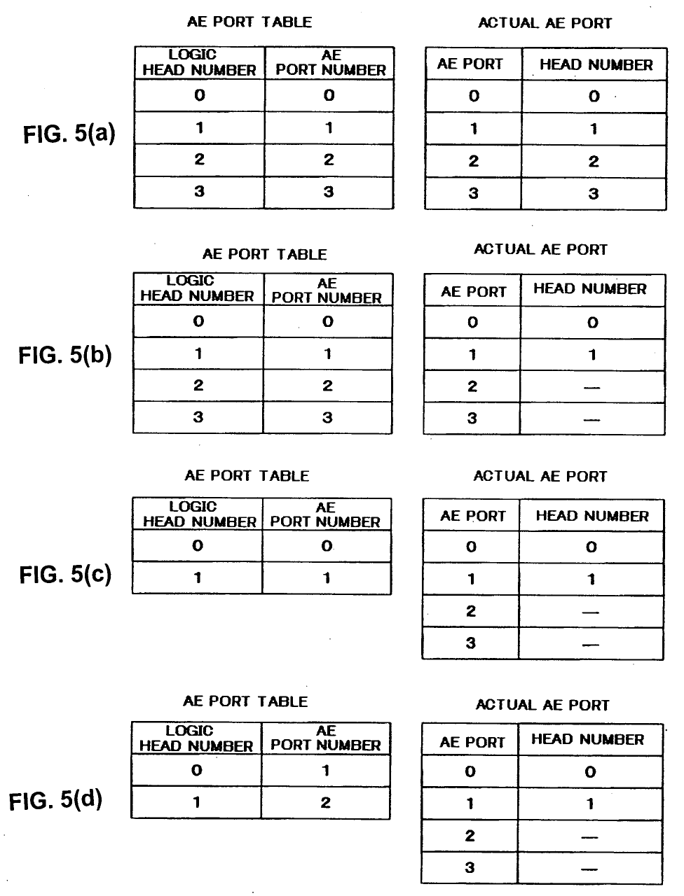

Referring next to FIGS. 5(a) to (d), the checking on the agreement between the AE port table 251 and the actual AE ports will be described in more detail. FIG. 5(a) shows an example of the AE port table 251. This example shows that AE port numbers 0 to 3 are in use. Specifically, logical head numbers 0 to 3 correspond to the AE port numbers 0 to 3, respectively. The right-side table of the actual AE ports indicates that the head device portions 12_0 to 12_3 are connected to the AE ports 132_0 to 132_3, respectively, as shown in FIG. 2.

The AE ports 0 to 3 shown in FIG. 5(a) correspond to the AE ports 132_0 to 132_3 shown in FIG. 2, respectively. The head device portions 12_0 to 12_3 correspond to the head device portions 12_0 to 12_3 shown in FIG. 2, respectively. Thus, the AE port table 251 shown in FIG. 5(a) and the actual head connecting state agree with each other.

In the example of FIG. 5(a), the setting of the AE port table 251 and the actual connection between the AE ports 132 and the head device portions 12 match. Therefore, the HDC/MPU 23 conducts a predetermined performance test (S413) without causing an AE port error, as described with reference to FIG. 4, and proceeds to the interface standby mode (S414).

The example of FIG. 5(b) will next be described. The AE port table in FIG. 5(b) is the same as the AE port table in FIG. 5(a). On the other hand, the number of head device portions that are actually connected to the AE 13 is two. Specifically, this corresponds to the example of FIG. 2 in which the head device portion 12_0 is connected to the AE port 132_0, and the head device portion 12_1 is connected to the AE port 132_1, respectively. No head device portions are connected to the other AE ports 132_2 and 132_3.

In this case, when the AE controller 131 checks the AE ports 132_0 and 132_1 corresponding to the AE port numbers 0 and 1, then no error is detected because the head device portions 12_0 and 12_1 are connected thereto. However, when the AE controller 131 checks the AE port 132_2 corresponding to the AE port number 2 according to the instruction from the AE-port checking controller 231, an AE port error is detected because the head device portions 12 is not connected thereto. The AE controller 131 stores the error result in the AE status register 133. As a result, the HDD 1 proceeds to the interface standby mode (S414) without conducting a predetermined performance test attended with spinning up and moving of the head, and thus the POR process is finished.

The example of FIG. 5(c) will now be described. In FIG. 5(c), the head device portion 12_0 is actually connected to the AE port 132_0, and the head device portions 12_1 is actually connected to the AE port 132_1, respectively, as in FIG. 5(b). On the other hand, the AE port table 251 shows that there are two head device portions, and that AE port numbers 0 and 1 are associated with logical head numbers 0 and 1, respectively.

In this case, when the checking of the AE ports corresponding to the AE port numbers 0 and 1 is executed, no error is detected because the head device portions 12_0 and 12_1 are connected to the AE ports 132_0 and 132_1, respectively. Accordingly, the HDC/MPU 23 comes into I/F Ready after a predetermined performance test (S413) without causing an AE port error.

The example of FIG. 5(d) will next be described. FIG. 5(d) shows that, actually, the head device portion 12_0 is connected to the AE port 132_0, and the head device portion 12_1 is connected to the AE port 132_1, respectively, as in FIGS. 5(b) and (c). The AE port table 251 shows that there are two head device portions, and that AE port numbers 1 and 2 correspond to logical head numbers 0 and 1, respectively. Thus, the AE port table 251 shown in FIG. 5(d) shows the information that the AE ports 132_1 and 132_2 shown in FIG. 2 are used and no other ports are used.

In this case, when the AE port number 1 is read and AE port checking is executed, no error is detected because the corresponding AE port 132_1 is connected to the head device portions 12_1. However, when the AE port number 2 is next read and checking is executed, an AE port error is detected because the corresponding AE port 132_2 is not connected to the head device portion 12. This fact is stored in the AE status register 133. As a result, the HDD 1 proceeds to the interface standby mode (S414) without conducting the predetermined performance test attended with spinning up and moving of the head, and the POR process is finished.

As described above, the AE port checking function of this embodiment can provide the same effects not only in reusing the circuit board 20 in the performance test prior to shipment, but also in reusing a used circuit board 20 having no problem when only the HDA has a defect.

The AE port checking in the POR process of the HDD 1 according to this embodiment can be completed only with the HDD 1 without an external instruction from a host or a tester.

The AE port checking function of this embodiment is effective particularly in reusing the circuit board 20 in the process of manufacturing the HDD 1. However, the HDD 1 may perform the AE port checking in the regular POR process after shipment. This can prevent the damage of the head device portion 12 or the magnetic disk 11 due to the unexpected action of the actuator 16 such as when the head device portion 12 is damaged and the HDD 1 does not start. When the magnetic disk 11 is not damaged, the data recorded on the magnetic disk 11 can be recovered after dismounting it from the HDD 1.

While the invention has been described according to the foregoing embodiments, the invention is not limited to these embodiments. For example, the relationship between the processes and the logical structure is not limited to the foregoing example. Designers can design data storage devices with efficient functions and circuit structures. The foregoing AE port checking may use a similar function mounted to a circuit other than the AE 13. To determine the condition of the head, the foregoing AE port checking may also adopt, in addition to the read-element open checking, write-element open checking or the function of measuring the resistance of a read element. For example, when the resistance of the read element is less than a reference value, the AE-port checking controller 231 determines that the read element cannot provide correct reading, and determines it to have an error.

In the foregoing description, the connecting state of the head device portions 12 is checked for all the AE port numbers set on the AE port table 251. Alternatively, only part of the head device portions 12 may be checked in some process (performance test) before the interface standby state. For example, only one head device portion 12 that reads servo data may be checked when the HDD 1 moves the actuator 16 from the retracted position onto the recording surface in the POR process. The AE port checking of this embodiment can be used irrespective of the number of the head device portions mounted on the HDD 1.

The AE port checking may be performed before the magnetic disk 11 spins up so as to omit unnecessary processes, as described above. However, even if the magnetic disk 11 spins up, defects due to an AE port error can be prevented provided that the actuator 16 is not activated. While the head device portions 12 of the foregoing embodiments is a recording and reproducing head capable of writing and reading, the invention can also be applied to a reproduction-only device, for example. While embodiments of the invention are useful particularly for HDDs, they can also be applied to devices that use other disks such as an optical disk.

What is claimed is:

1. A disk drive comprising:
one or a plurality of disks on which data is stored;
one or a plurality of heads that reads the data on the one or plurality of disks;
a head moving mechanism that supports and moves the one or plurality of heads;
one or a plurality of connecting portions connected to the one or plurality of heads, respectively; and
a controller that determines the condition of at least one of the heads registered on a table that associates the connecting portions with the one or plurality of heads with reference to the table before the head moving mechanism moves the head.

2. The disk drive according to claim 1, wherein
when the condition of the head is determined to be in error, the controller becomes communicable with an external unit before the head moving mechanism moves the head.

3. The disk drive according to claim 1, wherein
the controller executes the determination in the process of manufacturing the disk drive.

4. The disk drive according to claim 3, wherein
when the condition of the head is determined to be in error, the controller starts communication with an external unit before the head moving mechanism moves the head, and rewrites the table according to the instruction from the external unit.

5. The disk drive according to claim 1, wherein
the controller determines whether the head registered on the table is connected to the head connecting portion.

6. The disk drive according to claim 1, wherein
the controller executes the determination before the disk is rotated.

7. A method for controlling a disk drive including one or a plurality of heads that reads data from one or a plurality of disks and a head moving mechanism that supports and moves the one or plurality of heads, the method comprising:
referring to a table that associates connecting portions with the one or plurality of heads;
determining the condition of at least one of the heads registered on the table before the head moving mechanism moves the head; and
starting communication with an external unit before the head moving mechanism moves the head, when the determination indicates an error.

8. The method for controlling a disk drive, according to claim 7, wherein
the determination is made on the basis of the result of checking whether the head device is in open state.

9. A method for manufacturing a disk drive, the method comprising:
manufacturing a head disk assembly by mounting, in a case, one or a plurality of disks, one or a plurality of heads that reads data from the one or plurality of disks, a head moving mechanism that supports and moves the one or plurality of heads, and a preamplifier IC to which the one or plurality of heads are connected;
connecting a circuit board containing a memory that stores a table and a controller with the head disk assembly, the table associating connecting portions with the one or plurality of heads; and
determining the condition of at least one of the heads registered on the table by the controller before the head moving mechanism moves the head.
